(19) United States
(12) Patent Application Publication
(10) Pub. No.: US 2011/0117474 A1
(43) Pub. Date: May 19, 2011

(54) Solid electrolyte and electrochemical system including the solid electrolyte

(76) Inventor: Haruo Sawa, Kochi-ken (JP)

(21) Appl. No.: 12/656,287

(22) Filed: Jan. 25, 2010

Related U.S. Application Data
(63) Continuation of application No. 11/149,248, filed on Jun. 10, 2005, now abandoned.

(30) Foreign Application Priority Data
Jun. 10, 2004 (JP) 2004-173100

(51) Int. Cl. H01M 8/10

(52) U.S. Cl. 429/492

(57) ABSTRACT

Solid electrolyte comprising organic compound containing the organic polymer with hydroxyl group, inorganic compound, and water intended to provide the solid electrolyte that is less susceptible to performance deterioration even under high temperatures of 100° C. or higher and the electrochemical system using the said solid electrolyte.

It is a principal object of this invention to provide the basic means for producing the solid electrolyte comprising the hybrid compound where part of or all of the hydroxyl groups of the organic polymer with hydroxyl group are combined with at least one species of phosphoric acid and boric acid by immersing the hybrid compound in the solution containing at least one species of phosphoric acid and boric acid; otherwise by coating it with the said solution. Moreover, the said hybrid compound is made by neutralizing inorganic salt by acid in the raw material solution with the organic compound containing the organic polymer with hydroxyl group coexisting, removing solvent, where the solution after the neutralization process contains at least one species of phosphoric acid and boric acid. Hereby, part of or all of the hydroxyl groups of the organic polymer with hydroxyl group are combined with at least one species of phosphoric acid and boric acid.

### BACKGROUND OF THE INVENTION

The present invention relates to the highly conductive solid electrolyte for proton (hydrogen ion) or the highly conductive solid electrolyte for hydroxide ion, which is applicable to the fuel cell, etc, and the fuel cells and the other electrochemical systems in which the said solid electrolyte is used.

In the past, the electrolytic devices with the proton-conductive solid electrolyte, such as fuel cell, dehumidifier, electrolytic hydrogen generator, etc. have been put to practical use. In particular, the proton-conductive solid electrolyte operated under normal temperatures has been used for various purposes. For example, as to the polymer electrolyte fuel cells, a current and electric power are generated by the reaction composed of the electrochemical oxidation reaction of the hydrogen supplied to the negative electrode as shown in the formula (1), the electrochemical reduction reaction of the oxygen supplied to the positive electrode as shown in the formula (2), and the proton transfer through the electrolyte between the negative electrode and the positive electrode.

H₂→2H⁺+2e⁻ (1)

½O₂+2H⁺+2e⁻→H₂O (2)

The fuel is electrochemically oxidized in the negative electrode to emit proton also in the direct methanol fuel cells, where methanol is supplied as fuel, and in the other fuel cells, where the fuel other than hydrogen or methanol is supplied. Therefore, they can also be operated by employment of the proton-conductive solid electrolyte.

For example as electrolytic devices, an electrolytic hydrogen generator is put to practical use. This electrolytic hydrogen generator generates hydrogen in the reaction opposite to the above-mentioned formulas (1) and (2) of the fuel cell. By using it, high-purity hydrogen becomes obtainable even from water and electric power on site, and it has an advantage of making hydrogen-cylinder unnecessary. Moreover, in the case of employing solid electrolyte, electrolysis can be made only by supplying pure water without any electrolyte. The paper manufacturing industry also attempts to produce hydrogen peroxide for bleaching by the use of the formula (3) below in the similar system (see the nonpatent literature 1).

O₂+H₂O+2e⁻→HO₂⁻+OH⁻ (3)

The dehumidifier is constructed by the way that the proton-conductive solid electrolyte is sandwiched between both positive and negative electrodes in a manner similar to the case of fuel cell and hydrogen generator. When a voltage is applied between both positive and negative electrodes, water is separated into oxygen and proton components in the positive electrode by the reaction expressed in the formula (4) below. The proton that transfers to the negative electrode through the solid electrolyte is bound to oxygen in the air again, and is returned to water by the reaction expressed in formula (5). As a result of them, water transfers from positive electrode side to negative electrode side, which dehumidifies the positive electrode side.

H₂O→½O₂+2H⁺+2e⁻ (4)

½O₂+2H⁺+2e⁻→H₂O (5)

The principle of operation similar to that of electrolytic hydrogen generator is also capable of splitting water to dehumidify. For this reason, the air-conditioning equipment in which the moisture evaporation cold blast chiller is combined with it is also proposed (see nonpatent literature 2).

In any system put to practical use in the above, the parfluorosulfonic acid ion-exchange membrane represented by the Nafion® membrane is employed as a solid electrolyte. In addition, various sensors, electrochromic devices, etc. are essentially based on the principle of operation similar to the above, that is, they work by the principle in which the transfer of proton through the electrolyte between two different types of redox pair in positive and negative electrodes. Therefore, the proton-conductive solid electrolyte can be used. Currently, an experimental study of these systems with the proton-conductive solid electrolyte is also conducted.

For the hydrogen sensor, the change in electrode potential caused by the hydrogen concentration change with introduction of hydrogen, for example by the above formulas (4) and (5), can be utilized. Further, the proton-conductive electrolyte can be also applied to the humidity sensor in which the change in electrode potential or ion conductivity is utilized.

For example, in the case of the electrochromic device, coloring of WO₃ in the negative electrode by the reaction of formula (6) with an electric field applied. Its application includes the display device and the light shielding glass. This system is also operated by the transfer of proton to and from the negative electrode, and the proton-conductive solid electrolyte can be utilized.

WO₃+xH⁺+xe⁻→HxWO₃(Coloration) (6)

In addition, the primary cell, the secondary cell, the optical switch, the electrolytic water generator, etc. can be cited as the electrochemical system that can be operated by the use of proton-conductive solid electrolyte in principle. In the nickel hydride cell as an example of secondary cell, the hydrogen-absorbing alloy is used in the negative electrode, the nickel hydroxide is used in the positive electrode, and the alkaline electrolyte solution is used as electrolyte. As expressed by the formulas (7) and (8), the electrochemical oxidation-reduction of proton and the absorption of hydrogen into the hydrogen-absorbing alloy occur during charge or discharge in the negative electrode.

[Charge] H₂O+e⁻→H(storage)+OH⁻ (7)

[Discharge] H(Storage)+OH⁻→H₂O+e⁻ (8)

As expressed by the formulas (9) and (10), an electrochemical oxidation-reduction reaction of nickel hydroxide occurs in the positive electrode.

[Charge] Ni(OH)₂+OH⁻→NiOOH+H₂O+e⁻ (9)

[Discharge] NiOOH+H₂O+e⁻→Ni(OH)₂+OH⁻ (10)

This cell is charged and discharged by the transfer of proton or hydroxide ion in the electrolyte, and the proton-conductive solid electrolyte can be put to use in principle. However, the alkaline electrolyte solution has been used so far instead of the solid electrolyte.

For example, an optical switch where yttrium is used in the negative electrode is proposed (see nonpatent literature 3). The reason is that yttrium is hydrogenated and becomes permeable for light by an electric field applied to it, as shown in the formula (11) below. As a result, the permeability and the impermeability of light can be switched by an electric field. For this system, the proton-conductive electrolyte can also be used in principle. However, the alkaline electrolyte solution has been usually put to use.

Y+3/2H₂O+3e→YH₃+3OH (11)

The electrolytic water is the water that has undergone an electrolytic reaction. Its effect differs depending on the reduction side or the oxidation side. It is beneficial to health, killing the bacteria, a detergent, and fostering the growth of agricultural crops. It has versatile applications such as drinking water, cooking water, cleaning water, agricultural water, etc. An electrolytic reaction is accelerated by containing electrolyte in water. In the case that an electrolyte is dissolved in water, it needs to be removed when the water is used. If a solid electrolyte is used, an electrolyte does not have to be removed.

In most cases, the proton-conductive solid electrolyte operated at normal temperatures that has been so far used for the above electrochemical system is the parfluorosulfonic acid ion-exchange membrane represented by the Nafion® membrane. However, the electrolyte of parfluorosulfonic acid has a problem of being costly mainly due to the complexity of manufacturing process. Indeed, the economy effect of mass production of these electrolytes may help to reduce its price to a certain degree, but the inexpensive alternate materials are hoped.

Incidentally, the hybrid compounds of the organic polymers with hydroxyl group and various inorganic compounds are proposed as the materials of inexpensive and highly ion-conductive electrolyte that replaces the electrolyte of parfluorosulfonic acid. They are, for example, based on the hybrid compounds in a microscopic scale of polyvinyl alcohol and silicic acid compound (see the patent literature 1), polyvinyl alcohol and tungstic acid compound (see the patent literature 2), polyvinyl alcohol and molybdic acid compound (see the patent literature 2), polyvinyl alcohol and stannic acid compound (see the patent literature 3), and polyvinyl alcohol and zirconic acid (see the patent literature 4 and 5). For the other ingredients, at least one species of phosphorus, boron, aluminum, titanium, calcium, strontium, and barium compounds is added. They can be made by a simple process of neutralizing the inorganic salt as raw material in the solution where polyvinyl alcohol coexists. They are characterized by being low in cost. To the polyvinyl alcohol side, the proton conductivity as well as water resistance and strength are provided by being compounded with inorganic compound. On the other hand, to the inorganic compound side, flexibility is provided by being compounded with polyvinyl alcohol. As a result, a high-performance solid electrolyte is produced. These materials are treated by aldehyde, and this treatment acetalizes hydroxyl group of polyvinyl alcohol moiety. It is also possible that the excessive swelling by water absorption is inhibited (see the patent literature 6).
[Patent literature 1] Japanese patent unexamined publication No. 2003-007133 Publication of patent applications
[Patent literature 2] Japanese patent unexamined publication No. 2003-138084 Publication of patent applications
[Patent literature 3] Japanese patent unexamined publication No. 2003-208814 Publication of patent applications. Japanese Patent application No. 2002-4151
[Patent literature 4] Japanese patent application No. 2002-35832
[Patent literature 5] Japanese patent application No. 2002-310093
[Patent literature 6] Japanese patent application No. 2003-86442
[Nonpatent literature 1] Electrochemistry, 69, No 3, 154-159(2001)
[Nonpatent literature 2] Collected papers and lectures at national convention of Institute of Electrical Engineers in 2000, P3373 (2000)
[Nonpatent literature 3] J. Electrochem. Soc., Vol. 143, No. 10, 3348-3353(1996)

### SUMMARY OF THE INVENTION

Disclosed herein is the method for increasing the energy conversion efficiency of the above-mentioned fuel cell that is believed to be ideal if it is operated at higher temperature. If operated at high temperature, the quantity of platinum used for the electrode catalyst is reduced, and also becomes advantageous in cost. Particularly in the fuel cell in which the fuel of reformed hydrocarbons is utilized and the direct methanol fuel cell, the high temperature operation is favorable also because of reduction in poisoning of platinum catalyst by carbon monoxide produced.

Moreover, the high temperature operation is desirable for increase the energy conversion efficiency also in various electrolytic devices such as electrolytic hydrogen generator, etc. However, the above new solid electrolyte composed of the organic polymer with hydroxyl group and the inorganic compound has a problem of the proton conductivity gradually declined if it is set at the temperature of 100° C. or higher. If it is applied to the electrochemical system such as fuel cell, electrolytic device, etc., the operation temperature cannot be so high. In addition, the problem of the conductivity decline at higher temperature becomes more noticeable in the situation that humidity is not enough. Therefore, if operated at the temperature of 100° C. or higher, it is needed to apply pressure and raise the relative humidity, which makes the system large in scale. The problem of the conductivity decline at higher temperature is noticeable particularly in the dry circumstances. For this reason, the humidity level must be controlled and maintained at both start and stop of operation, and it makes the system complex.

For the solid electrolyte composed of the hybrid compound of polyvinyl alcohol and inorganic compound proposed by the above-mentioned patent literature 1 to 5, performance degradation at the higher temperature of 100° C. or higher is caused by degradation of polyvinyl alcohol moiety, for example, by becoming hydrophobic and hardening. The degradation of polyvinyl alcohol moiety includes the dehydration reaction within a polyvinyl alcohol molecule as shown in FIG. 1(a) and the hydrolytic condensation reaction within a polyvinyl alcohol molecule or between two polyvinyl alcohol molecules as shown in FIG. 1(b). Any of these reactions is a dehydration reaction, and easily occur particularly under the condition of low humidity or in the dry circumstances. If only polyvinyl alcohol is used, these reactions occur at temperatures of 300° C. or higher. For the hybrid compound of the above polyvinyl alcohol and inorganic compound, the inorganic compound functions as a catalyst, and the reactions as shown in FIGS. 1(a) and (b) occur even at lower temperature.

If the above reaction proceeds, hydrophilic property of polyvinyl alcohol decreases. As a result, the promoting effect of proton transfer caused by water molecule declines, which causes decrease of the proton conductivity. Besides, the whole material becomes hardened by decrease of the quantity of water that has an effect as a lubricating agent, which also prevents the molecular motion of polyvinyl alcohol moiety, so that the proton conductivity declines. Moreover, an oxidation reaction of polyvinyl alcohol by oxygen also causes degradation of polyvinyl alcohol moiety at high temperature. Also in this case, the hardening of the material occurs, which leads to the decline in proton conductivity.

Incidentally, it is characteristic of the hybrid compound of the above polyvinyl alcohol and inorganic compound that electrolyte membrane can be manufactured by the simple process of hybridization by neutralization reaction in the aqueous solution and by formation of membrane by the casting method from solution of the hybrid compound. When the electrolyte membrane is formed in such production method, heating process is carried out in order to make the electrolyte membrane with sufficient water resistance and strength. This heat treatment is carried out in the dry circumstances, because the hydrolytic condensation of inorganic compound or between inorganic compound and polyvinyl alcohol is used for improvement in water resistance and strength by heating.

To promote the above reaction efficiently, the heat treatment is carried out at temperatures of 100° C. or higher. However, if the heating proceeds excessively in the dry circumstances, the dehydration reaction also proceeds excessively as shown by FIG. 1(a) (b), and the formed electrolyte membrane is low in proton conductivity. Moreover, if hydrochloric acid is used in the neutralization reaction and hydrochloric acid exists excessively within the system, a substitution of chlorine for hydroxyl group of polyvinyl alcohol as shown by FIG. 1(c). In this case as well, the hydrophilic property of polyvinyl alcohol moiety declines, and causes hardening. Therefore, the proton conductivity lowers. For the solid electrolyte composed of the hybrid compound of the above polyvinyl alcohol and inorganic compound, in consequence, the temperature must be controlled to avoid excessive heating when the membrane is processed.

For the solid electrolyte composed of the hybrid compound of the above polyvinyl alcohol and inorganic compound, the proton conductivity can be improved by combining sulfuric acid with hydroxyl group of polyvinyl alcohol in the forms of hydrogen bond, sulfuric acid ester and sulfonic acid group by the method immersing in the solution including sulfuric acid, and so on. However, if this method is applied, the contained sulfuric components function as a catalyst to degrade the polyvinyl alcohol moiety as mentioned in the above. As a result, there occurs a problem of promoting the performance degradation at high temperature.

For the solid electrolyte composed of the hybrid compound of the above polyvinyl alcohol and inorganic compound, the excessive swelling due to water absorption and problems such as reduction in strength in humid circumstances can be inhibited by treatment with aldehyde and acetalization of the hydroxyl group of polyvinyl alcohol moiety. However, if the solid electrolyte that has undergone the above treatment is put to use under high temperature, the above mentioned performance degradation tends to occur in the early stage, because the hydrophilic property of solid electrolyte is already declined by the previous treatment. The problems explained in the above apply not only to polyvinyl alcohol, but also to solid electrolyte composed of the hybrid compound of the organic polymer with hydroxyl group and inorganic compound. Further, the enhanced stability of materials can extend the life span of solid electrolyte not only for use under high temperature such as fuel cell, but also for use under normal temperatures.

Therefore, the present invention is intended to solve the problems of the ion-conductive solid electrolyte containing the inorganic compounds such as silicic acid compound, tungstic acid compound, molybdic acid compound, stannic acid compound and zirconic acid compound plus the organic polymers with hydroxyl group such as polyvinyl alcohol, thereby providing the inexpensive solid electrolyte that not only undergoes a less material degradation under the high temperature of 100° C. or higher but also exhibits high performance and less performance degradation, as well as the electrochemical system in which such solid electrolyte is used.

### DETAILED DESCRIPTION OF THE INVENTION

To achieve the above objective, the present invention is intended for a hybrid compound containing the organic polymer with hydroxyl group, inorganic compound, and water. The hybrid compound is immersed in a liquid containing at least one species of phosphoric acid and boric acid; otherwise, it is coated with the said liquid. Specifically, it provides the solid electrolyte containing the hybrid compound where part of or all of the hydroxyl group of the organic polymer with hydroxyl group is combined with at least one species of phosphoric acid and boric acid, also various electrochemical systems in which this solid electrolyte is used.

The inorganic compound contains at least one species of silicic acid compound, tungstic acid compound, molybdic acid compound, stannic acid compound and zirconic acid compound. The hybrid compounds are made by neutralizing the inorganic salts by acid or alkali in the raw solution with the organic polymer with hydroxyl group coexisting, and then removing solvent. At least one species of metal salt of silicic acid, tungstic acid, molybdic acid and stannic acid is used as inorganic compound salt; otherwise, zirconium halide and/or oxyzirconium halide is used.

If the hybrid compound is prepared by the neutralization reaction, the process where part of or all of the hydroxyl group of the organic polymer with hydroxyl group is combined with at least one species of phosphoric acid and boric acid is carried out by the way that the solution after neutralization contains at least one species of phosphoric acid and boric acid. Further, at least one combining form of hydrogen bond, phosphoric acid ester or boric acid ester is formed as the bond between part of or all of the hydroxyl group of the organic polymer with hydroxyl group and at least one species of phosphoric acid and boric acid.

Polyvinyl alcohol is used as an organic polymer with hydroxyl group. If the hybrid compound is prepared by neutralization reaction, the hybrid compound in solid electrolyte can contain at least one species of phosphorus, boron, aluminum, titanium, calcium, strontium, and barium compounds by either of the following methods. At least one species selected from metal salt of phosphoric acid and boric acid is contained in the raw material solution before neutralization; otherwise, at least one species of aluminum salt, titanium salt, calcium salt, strontium salt, barium salt, and boric acid. Moreover, the treatment that the solid electrolyte is immersed in or coated by the solution containing at least one species of phosphoric acid and boric acid is carried out at 60° C. or higher.

To ensure the combining with at least one species of phosphoric acid and boric acid, the solution after neutralization is heated at 40° C. or higher, or preferably at 100° C. or higher under the situation that at least one species of phosphoric acid and boric acid is contained in it.

Part of the hydroxyl group of the organic polymer with hydroxyl group is combined with the sulfuric acid. It forms hydrogen bond, sulfuric acid ester or sulfonic acid group. To allow combining part of the hydroxyl groups of the organic polymer with hydroxyl group with sulfuric acid, the hybrid compound is immersed in the liquid containing sulfuric acid, coated with the above liquid, or exposed to the steam containing sulfuric acid with heating at 60° C. or higher.

Part of The hydroxyl group of the above organic polymer with hydroxyl group is combined with aldehyde. Combining with aldehyde is made by acetalization reaction.

To allow combining part of the hydroxyl groups of the organic polymer with hydroxyl group with aldehyde, the hybrid compound is immersed in the solution containing aldehyde and acid, coated with the above solution, or exposed to the steam containing aldehyde and acid. Besides, if the hybrid compound is prepared by neutralization reaction, at least one species of metal salt of silicic acid, tungstic acid, molybdic acid and stannic acid is used. Further, zirconium chloride or zirconium oxychloride is used as zirconium halide or oxyzirconium halide.

It is applicable to the electrochemical systems as follows; fuel cell, steam pump, dehumidification machine, air-conditioning equipment, electrochromic device, electrolytic device, electrolytic hydrogen generator, electrolytic hydrogen peroxide generator, electrolytic water generator, humidity sensor, hydrogen sensor, primary cell, secondary cell, optical switch, or new cell system using polyvalent metal.

### EFFECT OF THE INVENTION

According to the present invention:

A basic means for producing the solid electrolyte containing the hybrid compound where part of or all of the hydroxyl groups of the organic polymer with hydroxyl group are combined with at least one species of phosphoric acid and boric acid. For this purpose, the hybrid compound composed of the organic compound containing the organic polymer with hydroxyl group, inorganic compound, and water is immersed in the liquid containing at least one species of phosphoric acid and boric acid, or is coated with the above liquid; and

A basic means for producing the solid electrolyte containing the hybrid compound where part of or all of the hydroxyl groups of the organic polymer with hydroxyl group are combined with at least one species of phosphoric acid and boric acid. For this purpose, the hybrid compounds are made by neutralizing the inorganic salts by acid or alkali in the raw solution with the organic polymer with hydroxyl group coexisting, and then removing solvent. At this process, the above solution after neutralization contains at least one species of phosphoric acid and boric acid. Therefore, the present invention can provide both the inexpensive solid electrolyte that is less susceptible to performance degradation even for use at the high temperature of 100° C. or higher, and the electrochemical system in which the said solid electrolyte is used.

### DESCRIPTION OF THE PREFERRED EMBODIMENTS

Explained below are the concrete embodiments of the solid electrolyte relating to the present invention and the electrochemical system with the said solid electrolyte. The present invention refers to the hybrid compound composed of the organic compound containing the organic polymer with hydroxyl group, inorganic compound, and water, and is characterized by the solid electrolyte containing the hybrid compound where part of or all of the hydroxy groups of organic polymer are combined with at least one species of phosphoric acid and boric acid. For this purpose, the hybrid compound is immersed in the liquid containing at least one species of phosphoric acid and boric acid; otherwise, it is coated with the said liquid. Moreover, the present invention is characterized by the solid electrolyte containing the hybrid compound where part of or all of the hydroxy groups of organic polymer are combined with at least one species of phosphoric acid and boric acid. For this purpose, the hybrid compound prepared by neutralizing the inorganic salts by acid or alkali in the raw solution with the organic polymer with hydroxyl group coexisting, and then removing solvent. The said solution after neutralization contains at least one species of phosphoric acid and boric acid.

Explained below is how to prepare the solid electrolyte based on the embodiments of the present invention. For information, the invention under the present application is not limited to the description of embodiments.

### Embodiment 1

To make a solid electrolyte membrane, firstly 23 cc of the mixed aqueous solution of 7.5 weight percent sodium tungstate dehydrate (Na2WO4.2H2O), 3 weight percent trisodium phosphate (Na3PO4.12H2O) and 24 cc of aqueous solution of 3 weight percent sodium silicate were added into 100 cc of 10 weight percent aqueous solution of polyvinyl alcohol 3100 to 3900 in average degree of polymerization and 86 to 90% in degree of saponification to prepare the raw material aqueous solution. While this raw material aqueous solution was agitated, 12 cc of hydrochloric acid of 2.4M in concentration was dropped to neutralize and prepare the viscous precursor aqueous solution. This precursor aqueous solution was put in an airtight container and evacuated by vacuum pump for defoaming, and was kept at 40° C. in temperature for one hour and for 15 hours at normal temperature so that the compounding process could be promoted.

In the next, a polyester film was put on the flat and smooth pedestal of the coating equipment (manufactured by P K Print Coat Instruments Ltd. K Control Coater 202) equipped with the blade that allowed the adjustment of the gap with the pedestal. The defoamed precursor aqueous solution was cast over it. At this time, the pedestal was heated at 50° C. under control.

As soon as casting the precursor aqueous solution over the pedestal, the blade with the gap adjusted at 0.6 mm was swept over the precursor aqueous solution with a constant speed to smooth it into a constant thickness. It was heated at 50° C. to vaporize water from it. After fluidity was nearly lost, the precursor aqueous solution was cast again over it, and soon after that, the blade was swept again over the precursor aqueous solution to make it into a constant thickness. After this operation was repeated three times, the temperature of pedestal was raised to 105 to 110° C. Further, it was heated with this condition kept for two hours. Subsequently, the membrane formed on the pedestal was peeled, and dried after it was rinsed in water.

The solid electrolyte membrane prepared in this way was cut into 30 mm in diameter, and was first immersed in the aqueous solution of phosphoric acid of 10 weight percent and the 100 ml water containing 6 g of boric acid powder. The solid electrolyte membrane sample was immersed in each reaction liquid, and was kept at 60 to 100° C. for an hour under the state that the reaction liquid was being agitated. Subsequently, it was rinsed in water, and dried. The untreated sample was sample No. 1. The samples that underwent the above treatment were the samples No. 2 and No. 3, respectively. In the next, the solid electrolyte cut off in the above was immersed in the sulfuric acid of 1.8M in concentration at 60 to 100° C. for an hour. It was rinsed in water, and was given the sample No. 4. Further, the samples immersed in the aqueous solutions of phosphoric acid and boric acid under the similar condition of samples No. 2 and No. 3 after being treated with sulfuric acid were given the sample No. 5 and No. 6, respectively.

Each sample of these was put in a constant temperature and humidity chamber, and the ion conductivity was measured under the environment with the temperature and the relative humidity controlled at 60° C. and 90%, respectively. The ion conductivity was measured in the following way. First, the solid electrolyte membrane sample was sandwiched by two platinum discs of 28 mm in diameter and the brass disc placed outside the said platinum discs. It is further clipped by the insulated clip to stabilize further clips it. An alternating voltage of 10 mV was applied by LCR meter to the lead wire attached to the brass disc with changing the frequency from 5 MHz to 50 Hz to measure the response of electric current and phase angle. The ion conductivity was obtained from the intercept of the real number axis of the generally known Cole-Cole plot.

After the ion conductivity was measured, each sample was put in the 44 ml-capacity container of tetrafluoroethylene resin containing 10 cc of purified water. This container was put in the stainless pressure-resistant container, which was in turn set in the constant temperature chamber of 120° C. At this time, the solid electrolyte sample in the container of tetrafluoroethylene resin was not immersed directly in water, and the sample was set in the steam portion. After a lapse of predetermined time, the solid electrolyte sample was taken out, and the ion conductivity was measured in a manner similar to the above method under the condition of 60° C. in temperature and 90% in relative humidity. FIGS. 2 and 3 show the variations in ion conductivity of each sample against incubation time in the constant temperature chamber of 120° C.

As is clear from FIG. 2, the untreated sample (sample No. 1) loses its conductivity sharply if kept at a high temperature of 120° C. On the other hand, the samples (sample No. 2 and sample No. 3) immersed in the aqueous solution containing phosphoric or boric acid lost conductivity less. Clearly, the sample treated in particular by boric acid keeps the ion conductivity better. In the case of being kept at the high temperature of 100° C. or higher, the decline in conductivity is caused mainly by degradation with respect to hydroxyl group in the polyvinyl alcohol moiety as shown in the above FIGS. 1(a) and (b). The fact that the immersion in the aqueous solution containing phosphoric acid or boric acid inhibits the decline in conductivity shows that the hydroxyl group has undergone a change. The probable change in hydroxyl group caused by being immersed in phosphoric acid or boric acid is that phosphoric acid or boric acid combines with the hydroxyl group by hydrogen bond; otherwise, phosphoric acid or boric acid combines with hydroxyl group by the formation of phosphoric acid ester or boric acid ester (for example, as shown in FIGS. 4(a) and (b)). The occurrence of such combining can prevent the degradation of polyvinyl alcohol moiety with respect to hydroxyl group as shown in FIGS. 1(a) and (b).

Further, as is clear from FIG. 3, the effect of improvement in initial ion conductivity is achieved if it is immersed in the sulfuric acid. However, it is clear that the untreated sample (sample No. 4) decreases its conductivity sharply with time. On the other hand, the samples (sample No. 5 and No. 6) immersed in the aqueous solution containing phosphoric acid or boric acid decrease its conductivity less with time even if they are immersed in sulfuric acid beforehand. In this case as well, the sample immersed in boric acid retains the ion conductivity better. By immersion in sulfuric acid, the sulfuric acid combines with the hydroxyl group of polyvinyl alcohol moiety by hydrogen bond; otherwise, by forming sulfuric acid ester or sulfonic acid group (for example, as shown in FIGS. 5(a) and (b)). As a result, sulfuric acid is introduced into the solid electrolyte.

For the introduced sulfuric acid, the initial ion conductivity improves because it has a high degree of proton dissociation. However, it functions as a catalyst to degrade or oxidize polyvinyl alcohol as shown in the preceding FIGS. 1(a) and (b), and promotes the decline in ion conductivity at high temperature. By immersion in the aqueous solution containing phosphoric acid or boric acid, and by combining phosphoric acid or boric acid with hydroxyl group by hydrogen bond or phosphoric acid ester or boric acid ester (for example, as shown in FIGS. 4(a) and (b)), such degradation reaction or oxidation reaction can be inhibited.

### Embodiment 2

To prepare the raw material aqueous solution, 23 cc of mixed aqueous solution containing 7.5 weight percent of sodium tungstate dihydrate (Na2WO4.2H2O), 3 weight percent of trisodium phosphate (Na3PO4.12H2O), and 24 cc of aqueous solution containing 3 weight percent of sodium silicate were added to 100 cc of 10 weight percent aqueous solution containing 86 to 90% polyvinyl alcohol that was 3100 to 3900 in average degree of polymerization and 86 to 90% in degree of saponification. To neutralize it, 11 cc of hydrochloric acid of 2.4M in concentration plus additional 13 cc of 30 weight percent phosphoric acid were dropped in this raw material aqueous solution with agitation. In this way, the viscous precursor aqueous solution was prepared. Moreover, 6.7 weight percent of boric acid water solution was added in addition to hydrochloric acid and phosphoric acid to prepare another precursor aqueous solution in a manner similar to the above.

After being defoamed, these precursor aqueous solutions were heated at 40° C. for 24 hours to promote compounding and combining phosphoric acid and boric acid with the hydroxyl group of polyvinyl alcohol moiety. In the next, a membrane was formed in the way similar to Embodiment 1. For these samples that phosphoric acid was added in the raw material solution at neutralization process, phosphoric acid of liquid state remained in the membrane even after heating at 105 to 110° C. and vaporizing water. It shows clearly that the precursor aqueous solution of the membrane contained phosphoric acid. The fact that phosphoric acid exists in acid form as just described shows that the acid was added excessively beyond the point of neutralization during the neutralization operation. It shows that the precursor aqueous solution, where boric acid was added, also contained boric acid in boric acid form.

Of two species of sample, the solid electrolyte membrane prepared from the precursor aqueous solution where hydrochloric acid and phosphoric acid were added during neutralization was given the sample No. 7. On the other hand, the solid electrolyte membrane prepared from the precursor aqueous solution where hydrochloric acid, phosphoric acid, and boric acid were added during neutralization was given the sample No. 8. For these samples, the variations in ion conductivity were checked when they were kept at 120° C. in the same way as Embodiment 1. FIG. 6 shows the results. Both of these samples show the smaller decline in conductivity than the sample where the precursor aqueous solution does not contain phosphoric acid or boric acid after neutralization (see sample No. 1 in FIG. 2). From the above it reveals that the performance degradation of solid electrolyte at high temperature can be prevented by phosphoric acid or boric acid contained in the precursor aqueous solution after neutralization. The reason for such effect is that phosphoric acid or boric acid combines with the hydroxyl group of polyvinyl alcohol moiety by hydrogen bond; otherwise, by the formation of phosphoric acid ester or boric acid ester in a manner similar to the case of Embodiment 1 (for example, as shown in FIGS. 4(a) and (b)) because the precursor aqueous solution contains phosphoric acid and/or boric acid after neutralization. The occurrence of such combining can prevent the degradation of polyvinyl alcohol moiety with respect to hydroxyl group as shown in FIGS. 1(a) and (b).

Besides, if only the hydrochloric acid is used during neutralization as shown in Embodiment 1, the prolonged heating at temperature of 100° C. or higher during the process of membrane formation hardens the produced membrane and lowers water-absorption. For this reason, the heating time must be strictly controlled. However, if the precursor solution after neutralization contains phosphoric acid or boric acid as in the case of the Embodiment, the membrane degrades less even if the heating at temperature of 100° C. or higher is prolonged during the process of membrane formation. Therefore, the heating time need not to be controlled strictly. Specifically, it tends to reduce the variations of products in manufacturing. If the only hydrochloric acid is used during neutralization as in the case of Embodiment 1, substitution of chlorine for the hydroxyl group of polyvinyl alcohol is occurred during heating as shown in FIG. 1(c). It lowers the hydrophilic property, and causes the hardening. On the other hand, if the quantity of hydrochloric acid is decreased and phosphoric acid or boric acid is contained in the precursor solution after neutralization as in the case of Embodiment 2, the substitution of chlorine for the hydroxyl group of polyvinyl alcohol moiety is inhibited. As a result, the degradation can be prevented.

### Embodiment 3

The samples No. 1 and No. 3 in Embodiment 1 and the sample No. 7 in Embodiment 2 were kept at 120° C. in the dry state (under atmosphere) to check the variations in ion conductivity with time. The conductivity was checked under the same condition as Embodiment 1 or Embodiment 2 where the temperature was 60° C. and the relative humidity was 90%. FIG. 7 shows the results. The sample No. 1 where the precursor aqueous solution after neutralization did not contain phosphoric acid or boric acid, and did not undergo any treatment shows sharp decrease in conductivity in the dry circumstances than in the humid circumstances of Embodiment 1. However, the sample No. 3 immersed in the solution containing boric acid in advance and the sample No. 7 where the precursor aqueous solution after neutralization operation contained phosphoric acid clearly shows less decrease in conductivity.

### Embodiment 4

For the solid electrolyte membrane, the samples No. 1 and No. 3 in Embodiment 1 and the sample No. 7 in Embodiment 2 were treated with aldehyde. To carry out treatment with aldehyde, the solid electrolyte was first immersed in the hydrochloric acid of 1.2M in concentration at normal temperature for one hour.

Subsequently, it was immersed in 100 cc of the hydrochloric acid of 1.2M in concentration containing 10 cc of isobutyl aldehyde for two hours with agitation at normal temperature. In the next, it was rinsed in hot water of 70 to 100° C., and was kept at 120° C. in saturated steam to measure the variations in ion conductivity with time. FIG. 8 shows the results.

As is clear from the results shown in FIG. 8, the conductivity of the sample No. 1, where the precursor aqueous solution after neutralization operation did not contain phosphoric acid or boric acid and no treatment was carried out, was reduced under high temperatures at an early stage by being treated with aldehyde. However, the sample No. 3 immersed in the aqueous solution containing boric acid beforehand and the sample No. 7 where the precursor aqueous solution after neutralization operation contained phosphoric acid shows less decrease in conductivity at high temperature. The treatment by aldehyde already decreased the hydrophilic property of solid electrolyte at the time of treatment. Therefore, the decline in conductivity under high temperature caused by degradation reaction of polyvinyl alcohol as shown in FIGS. 3(a) and (b) was quickened. On the other hand, the samples No. 3 and No. 7 where the hydroxyl group of polyvinyl alcohol moiety was combined with boric acid and/or phosphoric acid were more resistant to the degradation reaction of polyvinyl alcohol. The conductivity decrease under high temperature does not occur easily even if the hydrophilic property was lowered by aldehyde treatment.

In each Embodiment above, the sample was either immersed or coated with the liquid containing at least one species of phosphoric acid and boric acid so that phosphoric acid or boric acid could combine with the hydroxyl group of organic polymer. However, any liquid is acceptable for this purpose as long as the desired bond of phosphoric acid or boric acid can occur. Therefore, phosphoric acid or boric acid does not necessarily have to be dissolved. Phosphoric acid or boric acid combines with the hydroxyl group of organic polymer by hydrogen bond and/or by formation of phosphoric acid ester and/or boric acid ester as shown in FIG. 9. These combined species and binding types may be mixed. If phosphoric acid or boric acid is combined, the condensed phosphoric acid (as shown in FIG. 9(a)) where two or more phosphoric acids are condensed or the condensed boric acid (as shown in FIG. 9(b)) where two or more boric acids are condensed may be used; otherwise, they may be combined with the hydroxyl group of organic polymer in mixed and condensed form of phosphoric acid and/or boric acid. If immersed or coated with the liquid containing phosphoric acid and/or boric acid, the sample is preferably heated at temperature of 60° C. or higher. The higher is the temperature, the higher becomes the solubility of the compound. Besides, the combining reaction with solid electrolyte is also promoted. It is also effective to carry out the treatment in the pressure-resistant container at temperature higher than the boiling point of processing solution.

Each embodiment is based on enhancing the durability at high temperature by combining phosphoric acid and/or boric acid to the hydroxyl group of organic polymer. For this reason, it is effective for any solid electrolyte comprised of the hybrid compound of organic compound of the organic polymer with hydroxyl group and inorganic compound. In the present invention, polyvinyl alcohol, various types of cellulose, polyethylene glycol, various organic polymers where hydroxyl group is introduced, or organic polymer that is co-polymerized or graft polymerized with organic polymer with hydroxyl group are included in the organic polymer with hydroxyl group. For example, polyvinyl alcohol is the most representative one in the present invention. However, polyvinyl alcohol does not have to be perfect. It can be put to use as long as it functions essentially as polyvinyl alcohol. Specifically, polyvinyl alcohol where part of the hydroxyl group is replaced by another group or another polymer is in part co-polymerized or graft polymerized can also function as polyvinyl alcohol. Moreover, the similar effect can be achieved if polyvinyl alcohol is generated through in the reactive process. Therefore, polyvinyl acetate, etc. used as raw materials of polyvinyl alcohol may also be accepted as starting material.

Besides, in each Embodiment, as long as the function of the organic polymer with hydroxyl group acts sufficiently, the other polymers including the polyolefin polymers such as polyethylene, polypropylene, etc., the polyesters such as polyethylene terephthalate, polybutylene terephthalate, etc., the fluorinated polymers such as polytetra fluoroethylene, polyvinylidene fluoride, etc., the polyvinyl acetate polymers, the polystyrene polymers, the polycarbonate polymers, the epoxy resin polymers, or the other organic and inorganic additives may be mixed.

In each Embodiment, the hybrid compound can be prepared by neutralizing the inorganic compound salt by acid or alkali in the raw material solution where the organic compound containing the organic polymer with hydroxyl group coexists. In this case, the typical example of inorganic compound salt is the oxygen acid salt of metal. For example, at least one species of metal salt including silicic acid, tungstic acid, molybdic acid, and stannic acid can be used. In this case, acid is used for neutralization. Any species of metal salt including silicate, tungstate, molybdate, or stannate is acceptable as long as they are dissolved in the solvent. Any species of metal ion, ratio of oxygen/positive ion, or water content is acceptable.

In addition, another typical example of inorganic compound salt is halide or oxyhalide. For example, zirconium halide or oxyzirconium halide can be put to use where alkali is used for neutralization. Any species of zirconium salt and oxyzirconium salt is also acceptable as long as they are dissolved in the solvent. Besides, any ratio of oxygen/negative ion, and water content is acceptable. Any solvent of raw material solution is acceptable as long as it can dissolve the metal salt and the organic polymer that serves as a raw material. In this regard, however, water is suitable because the solubility of metal salt is high. For the metal salt of silicic acid, tungstic acid, molybdic acid, and stannic acid, the alkali metal salt is preferable in terms of the solubility.

If the solid electrolyte is prepared by the above neutralization method, phosphoric acid or boric acid can be combined with the hydroxyl group of organic polymer by the situation that the solution after neutralization contains at least one species of phosphoric acid and boric acid. To ensure that phosphoric acid and/or boric acid are contained, the solution after neutralization must be acidic. Therefore, the oxygen acid salt of metal is mainly used as the inorganic compound salt in this case, which is neutralized by acid. At this time, the acid must be added excessively beyond the point of neutralization so that the solution after neutralization can be acidic. The most typical method to ensure that the solution after neutralization can contain phosphoric acid and/or boric acid is to add acid containing phosphoric acid and/or boric acid excessively beyond the point of neutralization, or to add phosphoric acid and/or boric acid after adding acid excessively beyond the point of neutralization. If the solution after neutralization contains phosphoric acid and/or boric acid, phosphoric acid and/or boric acid combines with the hydroxyl group of organic polymer with hydroxyl group by hydrogen bond or the formation of phosphoric acid ester or boric acid ether as shown in FIG. 4. These species and types of bond may be mixed. If the solution after neutralization contains at least one species of phosphoric acid and boric acid to allow phosphoric acid and/or boric acid to combine with the hydroxyl group of organic polymer, combining can be promoted by heat treatment at the temperature of 40° C. or higher in any process after neutralization. In addition, if the solution after neutralization contains phosphoric acid, phosphoric acid remains in the membrane as the liquid form even after removing the solvent and making into, for example, the membrane form. By heating at the temperature of 100° C. or higher in this situation, combining can be promoted.

At least one species of phosphorus, boron, aluminum, titanium, calcium, strontium, and barium compounds can be contained in the hybrid compound making up the solid electrolyte. If the neutralization method is adopted for preparation, these compounds can be added by ensuring that the raw material solution before neutralization contains at least one species of metal salt selected from phosphoric acid and boric acid; otherwise, at least one species selected from aluminum salt, titanium salt, calcium salt, strontium salt, barium salt, and boric acid. Any type of metal salt including phosphoric acid or boric acid is acceptable as long as it is dissolved in the solvent used. Any type of metal ion, oxygen/positive ion ratio, and water content is acceptable. In this regard, however, it is desirable that the alkali metal salt is used in terms of solubility of metal salt. Any type of aluminum salt, titanium salt, calcium salt, strontium salt, or barium salt is acceptable as long as they can be dissolved in the solvent. Any type of negative ion and water content is also acceptable. Moreover, if phosphorus, boron, or silicon is added, the heteropoly acids such as tungstophosphoric acid, molybdophosphoric acid, silicotungstic acid, silicomolybdic acid, tungstoboric acid, or molybdoboric acid where tungstic acid or molybdic acid and phosphoric acid, silicic acid, or boric acid is chemically combined in advance plus their salts can also be used as raw materials.

If prepared by neutralization method, any type of acid or alkali used for neutralization is acceptable as long as it can neutralize the metal salt of silicic acid, tungstic acid, molibdic acid, or stannic acid; otherwise, it can neutralize zirconium salt, or oxyzirconium salt. Hydrochloric acid, sulfuric acid, phosphoric acid, sodium hydroxide, lithium hydroxide, etc. can be used.

By heating the solid electrolyte in the present invention at temperatures 100° C. or higher, the bond formation with inorganic compound and organic compound is promoted, and its strength, water resistance, and stability under high temperature increase. Unless heated, the problems such as decline of strength in high-temperature water, etc. occur. The heating process may be carried out in the air, in the inert gas atmosphere, or in vacuum.

If the acid type proton conductivity solid electrolyte is obtained, the ion conductivity can be raised by immersing the produced hybrid compound into acid, and by causing complete protonation of proton site in the material to increase the proton concentration. Any immersion acid may be available as long as it can achieve protonation. Hydrochloric acid, sulfuric acid, etc. may be suitable for use. Particularly, if the sulfuric acid is used, it combines with the hydroxyl group of polyvinyl alcohol moiety by hydrogen bond; otherwise, by the formation of sulfuric acid ester or sulfonic acid group as shown in FIG. 5, thereby contributing to the enhancing the proton conductivity.

The acid immersion process is particularly effective in the electrolyte containing tungstic acid compound. It is desirable that the acid immersion process is carried out before immersion or coating with the solution containing phosphoric acid and/or boric acid. Besides, phosphoric acid and/or boric acid can be also put in the processing solvent beforehand when the acid immersion process is carried out.

Due to using the inexpensive material and being based on the simple manufacturing process, the solid electrolyte obtained by the present invention is considerably lower in price than the established electrolyte of parfluorosulfonic acid system. Further, the solid electrolyte relating to the present invention has the function similar to the solid electrolyte composed of the established hybrid compound of polyvinyl alcohol and inorganic compound. It permits applications to the similar use. Therefore, it can be applied to the electrochemical system including fuel cell, steam pump, dehumidification machine, air-conditioning equipment, electrochromic device, electrolytic equipment, electrolytic hydrogen generator, hydrogen peroxide generator, humidity sensor, hydrogen sensor, primary cell, secondary cell, optical switch system, or the new cell system using polyvalent metals.

As explained above, the present invention refers to the hybrid compound composed of the organic compound of the organic polymer with hydroxyl group, inorganic compound, and water. Specifically, it is the solid electrolyte comprising the hybrid compound where part of or all of the hydroxyl groups of the organic polymer are combined with at least one species of phosphoric acid and boric acid by being immersed in the solution containing at lease one species of phosphoric acid and boric acid or being coated with the said solution. It also refers to the solid electrolyte comprising the hybrid compound where part of or all of the hydroxyl groups of the organic polymer with hydroxyl group are combined with at least one species of phosphoric acid and boric acid because the said solution after neutralization contains at least one species of phosphoric acid and boric acid. Specifically, it is the hybrid compound composed of organic compound, inorganic compound, and water prepared by neutralizing the inorganic compound salt by acid in the raw material solution where the organic compound containing the organic polymer with hydroxyl group coexists, and removing the solvent. For this reason, it can provide the solid electrolyte that is not only less susceptible to degradation or performance deterioration even under the high temperature condition of 100° C. or higher, but also inexpensive, and sophisticated. Besides, it can also provide various electrochemical systems in which the said solid electrolyte is used. As an electrochemical system, it can be applied to fuel cell, steam pump, dehumidification machine, air-conditioning equipment, electrochromic device, electrolytic equipment, electrolytic hydrogen generator, electrolytic hydrogen peroxide generator, electrolytic water generator, humidity sensor, hydrogen sensor, primary cell, secondary cell, optical switch system, or new cell system using the polyvalent metals.

### BRIEF DESCRIPTION OF THE DRAWINGS

Referring now to the following Figures, in which:

FIGS. 1(a), (b), and (c) shows the reaction of the hydroxyl group of polyvinyl alcohol moiety.

FIG. 2 shows the variations in ion conductivity of the samples No. 1, No. 2, and No. 3 when they are set in saturated steam.

FIG. 3 shows the variations in ion conductivity of the samples No. 4, No. 5, and No. 6 immersed in sulfuric acid beforehand when they are set in saturated steam.

FIG. 4 shows the formation of phosphoric acid ester (a) and boric acid ester (b) at the hydroxyl group of polymer.

FIG. 5 shows the formation of sulfuric acid ester (a) and sulfonic acid group (b) at the hydroxyl group of polymer.

FIG. 6 shows the variations in ion conductivity of the samples No. 7 and No. 8 when they are set in saturated steam.

FIG. 7 shows the variations in ion conductivity of the samples No. 1, No. 3, and No. 7 when they are set under the atmosphere.

FIG. 8 shows the variations in ion conductivity of the samples No. 1, No. 3, and No. 7 when they are set in saturated steam.

FIG. 9 shows the formation of phosphoric acid ester (a) of condensed phosphoric acid and boric acid ester (b) of condensed boric acid at the hydroxyl group of organic polymer.

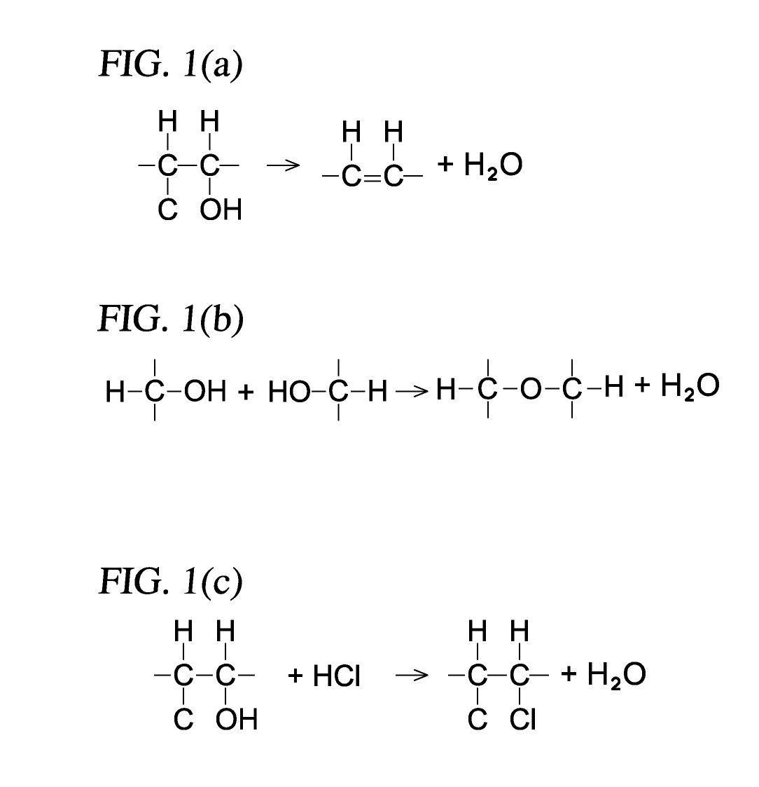

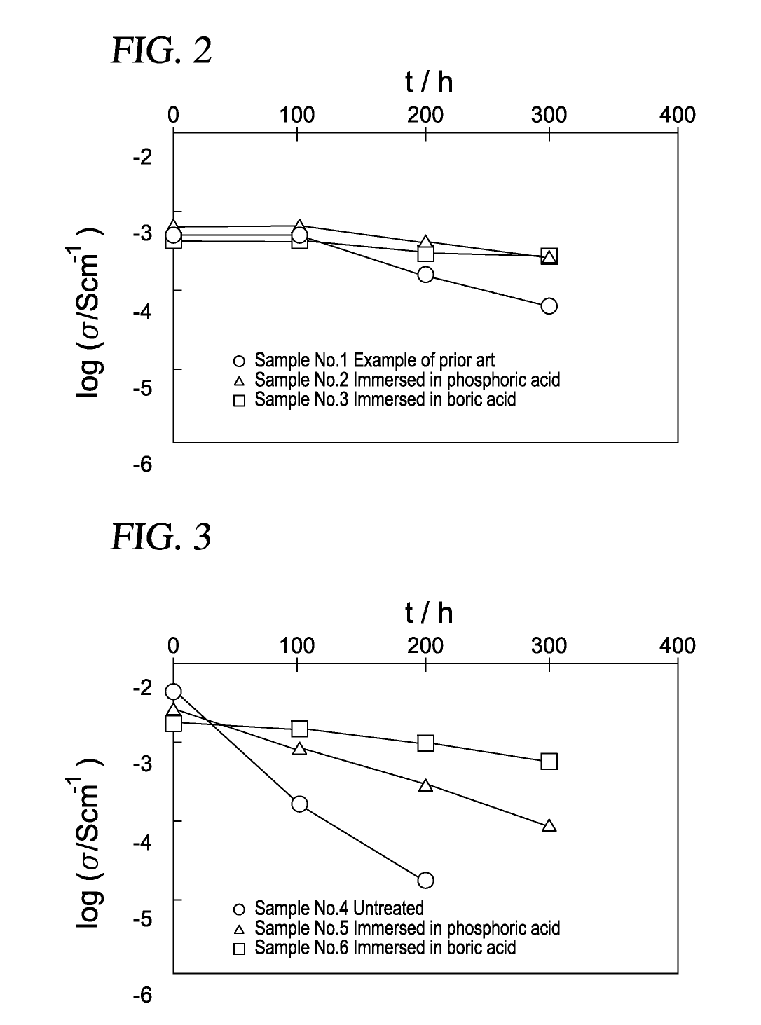

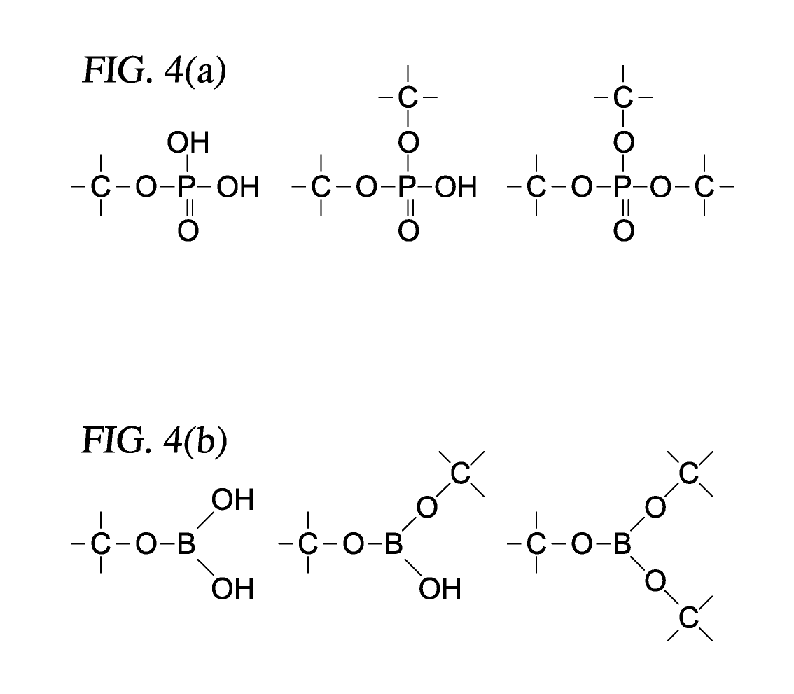

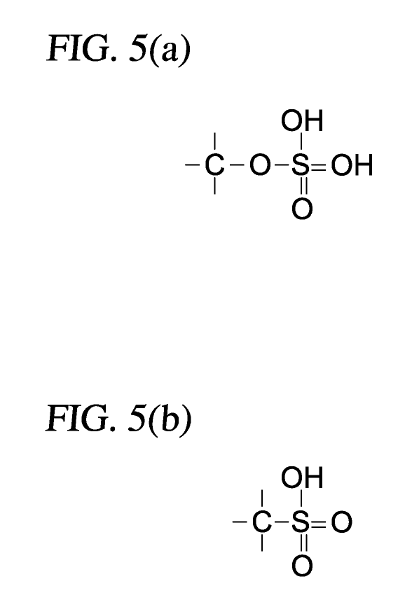

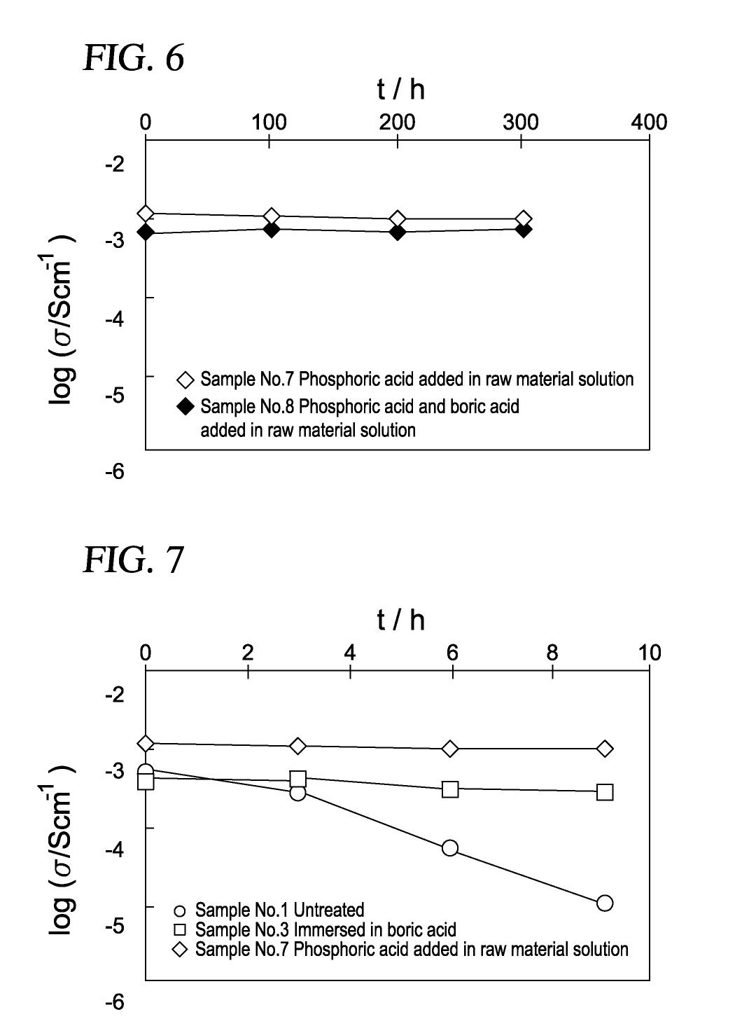

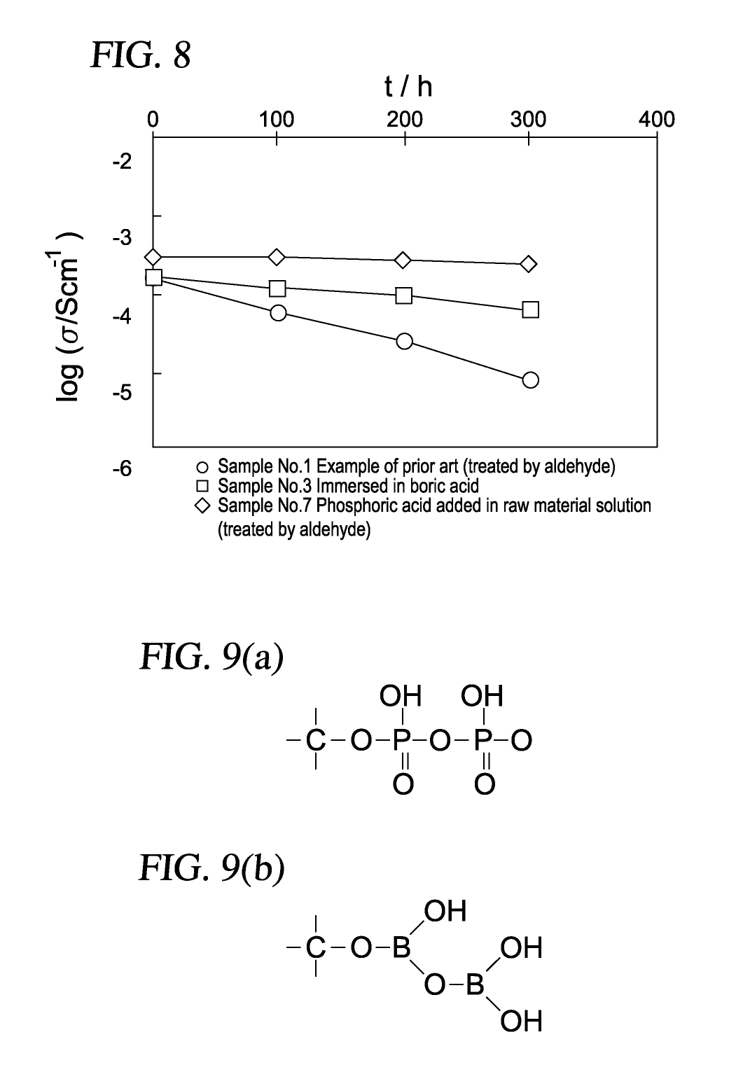

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. A method for improving the proton conductivity of a solid electrolyte comprising a hybrid compound composed of an organic compound containing an organic polymer having at least one hydroxyl group, an inorganic compound and water, the method comprising the steps of immersing the hybrid compound in a liquid that contains at least one species of phosphoric acid and boric acid or coating the hybrid compound in a liquid that contains at least one species of phosphoric acid and boric acid.

25. The method of claim 1 wherein the inorganic compound contains at least one species selected from the group consisting of a silicic acid compound, a tungstic acid compound, a molybdic acid compound, a stannic acid compound and a zirconic acid compound.

26. The method of claim 1 wherein the hybrid compound is prepared by neutralizing the inorganic compound salt by acid or alkali in a raw material solution and where the organic compound containing the organic polymer with hydroxyl group coexists, and thereafter removing the solvent.

27. The method of claim 26 wherein the inorganic compound salt is at least one species of metal salt of silicic acid, tungstic acid, molybdic acid, and stannic acid; otherwise, it is zirconium halide and/or oxyzirconium halide.

28. The method of claim 27 and wherein the metal salt of silicic acid, tungstic acid, molybdic acid and stannic acid is an alkali metal.

29. The method of claim 27 wherein the zirconium halide or oxyzirconium halide is zirconium chloride or zirconium oxychloride.

30. The method of claim 24 and wherein the organic polymer with at least one hydroxyl group is polyvinyl alcohol.

31. The method of claim 24 wherein the hybrid compound is either immersed in a liquid containing at least one species of phosphoric acid and boric acid, or it is otherwise coated with the liquid containing at least one species of phosphoric acid and boric acid while being heated to a temperature of 60° C. or higher.

32. The method of claim 24 wherein the hybrid compound is immersed in a liquid containing sulfuric acid or coated with the liquid containing sulfuric acid prior to being immersed in or coated with the liquid containing at least one species of phosphoric acid and boric acid.

33. The method of claim 32 wherein the hybrid compound is immersed in a liquid containing sulfuric acid or is coated with the liquid containing sulfuric acid while being heated at a temperature of 60° C. or higher.
